(19) United States
(12) Patent Application Publication
(10) Pub. No.: US 2011/0121599 A1
(43) Pub. Date: May 26, 2011

(54) Integrated Center of Dash Food and Beverage Warmer/Cooler

(75) Inventors: Gerald M. Goupil, JR., N. Tonawanda, NY (US); Mark W. Stevenson, Appleton, NY (US); John L. Pawlak, III, Orchard Park, NY (US)

(73) Assignee: Delphi Technologies, Inc., Troy, MI (US)

(21) Appl. No.: 12/625,781

(22) Filed: Nov. 25, 2009

(51) Int. Cl. B60R 7/06; B60H 3/00; F25D 21/14; F24F 7/00

(52) U.S. Cl. 296/37.12; 165/43; 62/285; 165/59

(57) ABSTRACT

An HVAC system includes a housing defining an auxiliary aperture, an occupant aperture, a circulation aperture, an inlet opening, a drip aperture, having at least one treatment device disposed therein, and defines a pre-treatment space between the inlet opening and the treatment device. An instrument panel has a façade and a backside opposite the façade and defines a passage extending from the façade to the backside and terminates at the housing. An auxiliary article module is disposed in the passage, abuts the housing and has walls defining an auxiliary article compartment, an auxiliary hole, an outer circulation hole, and a drip hole. The holes and their corresponding apertures are aligned and abutting for receiving air and liquid between the housing and the auxiliary article compartment. A circulation duct extends between the circulation aperture and the pre-treatment space for carrying air therebetween.

### BACKGROUND OF THE INVENTION

1. Field of the Invention

A vehicle having an instrument panel including an auxiliary article compartment.

2. Description of the Prior Art

The prior art includes vehicles routing treated air from the housing of an HVAC system to an auxiliary article compartment. U.S. Pat. No. 7,389,650 (Kuckucka) discloses an instrument panel that has a façade and a backside opposite the façade and defines a passage. An HVAC system includes a housing. The housing abuts the backside of the instrument panel and defines an auxiliary aperture for permitting flow of air and an occupant aperture for permitting flow of air and has at least a first treatment device disposed therein for treating air. An auxiliary article module has walls defining an auxiliary article compartment and an auxiliary hole for permitting flow of air into the auxiliary article compartment.

### SUMMARY OF THE INVENTION

In the invention, the passage extends from the façade to the backside of the instrument panel and terminates at the housing, and the auxiliary article module is disposed in the passage and abuts the housing with the auxiliary hole being aligned with and abutting the auxiliary aperture for receiving air from the housing into the auxiliary article compartment.

### ADVANTAGES OF THE INVENTION

This invention simplifies the construction of the instrument panel by eliminating hosing and duct work to route treated air between the HVAC housing and the auxiliary article compartment which reduces the materials and assembly cost of the vehicle. The thermal losses incurred by the flow of air between the HVAC housing and the auxiliary article compartment are also accordingly minimized to improve the efficiency of the vehicle while increasing operator comfort.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view of a sector of a vehicle in accordance with an embodiment of the subject invention;

FIG. 2 is a side view of a sector of a vehicle in accordance with an embodiment of the subject invention;

FIG. 3 is an electrical schematic in accordance with an embodiment of the subject invention;

FIG. 4 is a side view of a sector of an auxiliary article compartment in accordance with an embodiment of the subject invention;

FIG. 5 is a side view of a sector of an ejection-retention mechanism in accordance with an embodiment of the subject invention;

FIG. 6 is a front view of an auxiliary article compartment in accordance with an embodiment of the subject invention;

FIG. 7 is perspective view of an auxiliary article compartment in accordance with an embodiment of the subject invention;

FIG. 8 is a perspective view of an auxiliary article compartment in accordance with an embodiment of the subject invention;

FIG. 9 is a perspective view of an auxiliary article compartment in accordance with an embodiment of the subject invention;

FIG. 10 is a perspective view of an auxiliary article compartment in accordance with an embodiment of the subject invention.

### DETAILED DESCRIPTION OF THE INVENTION

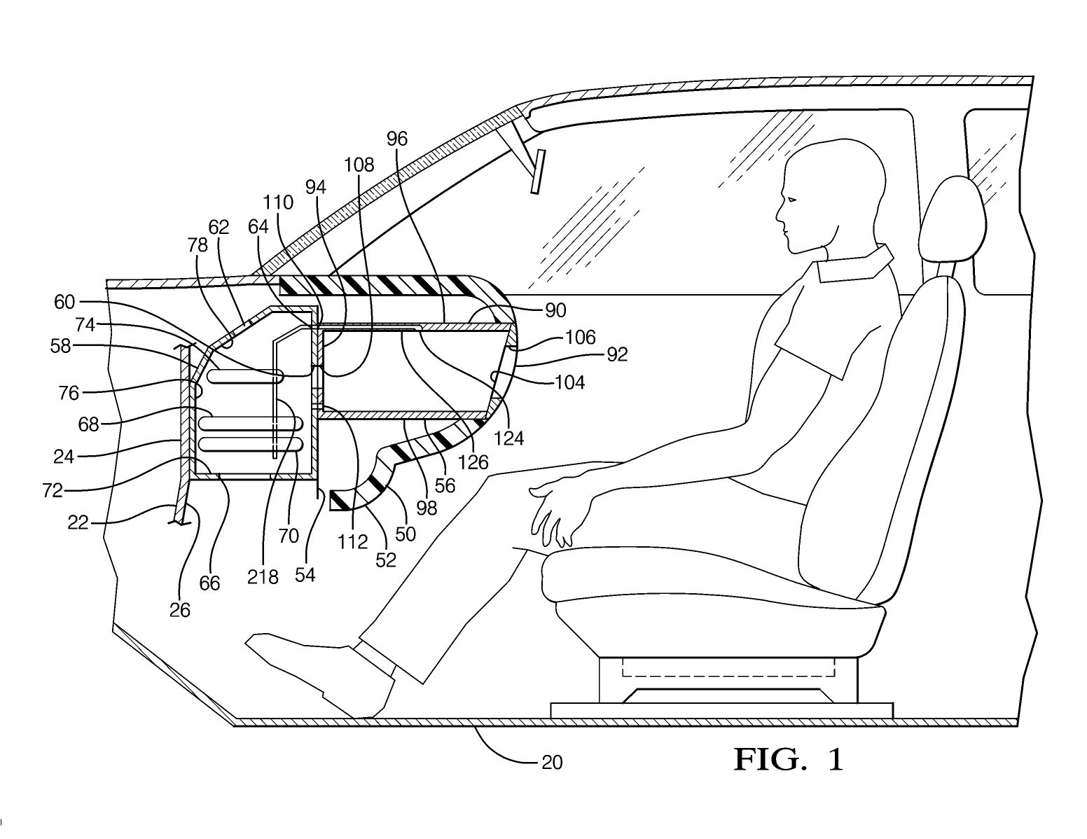

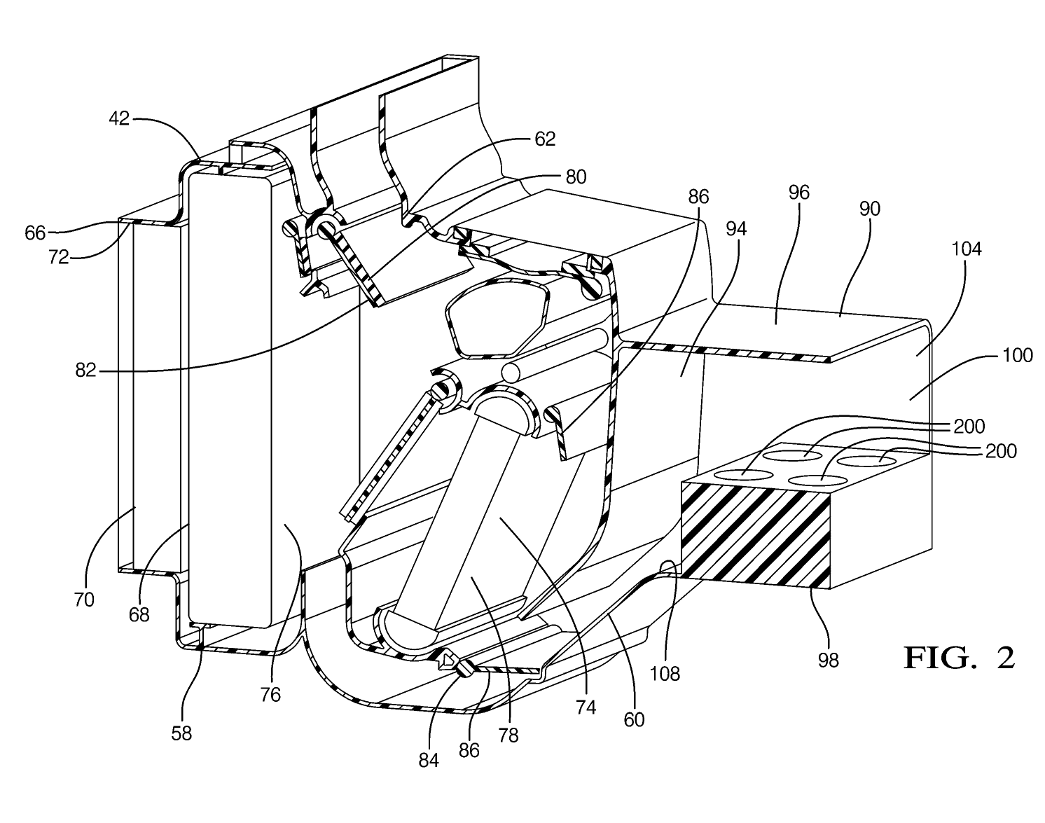

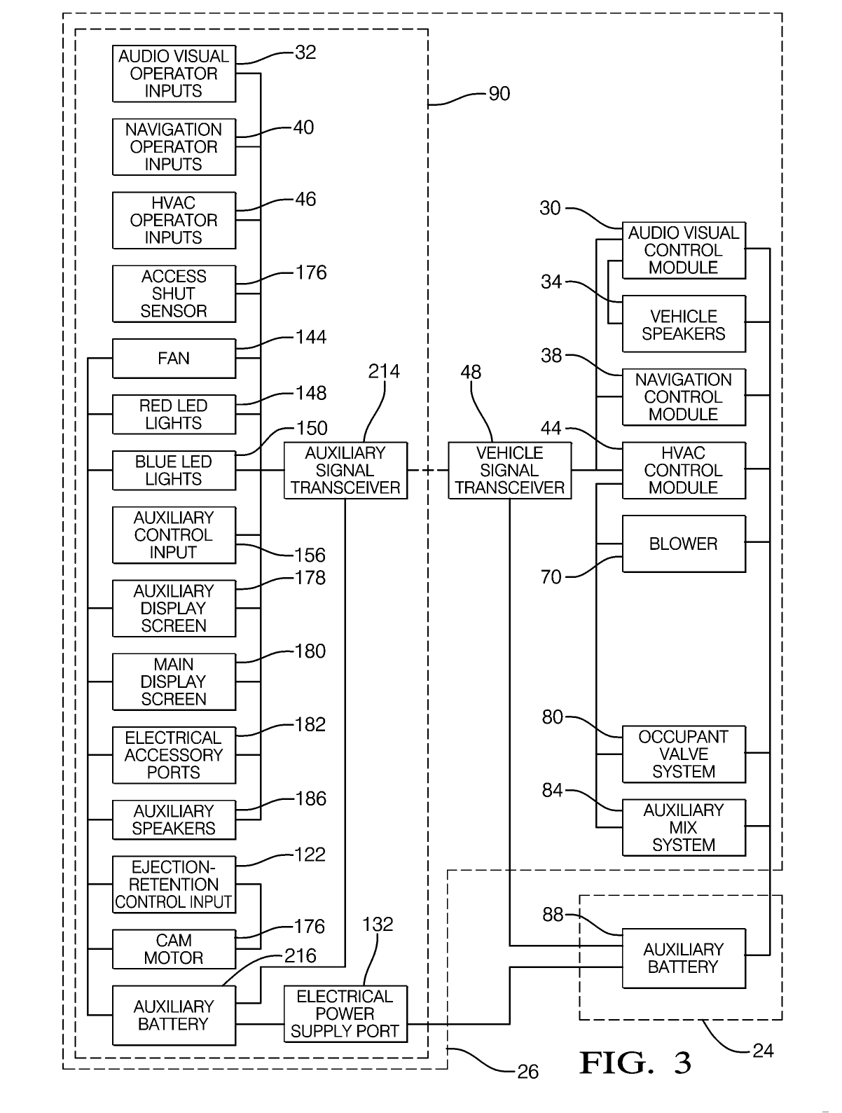

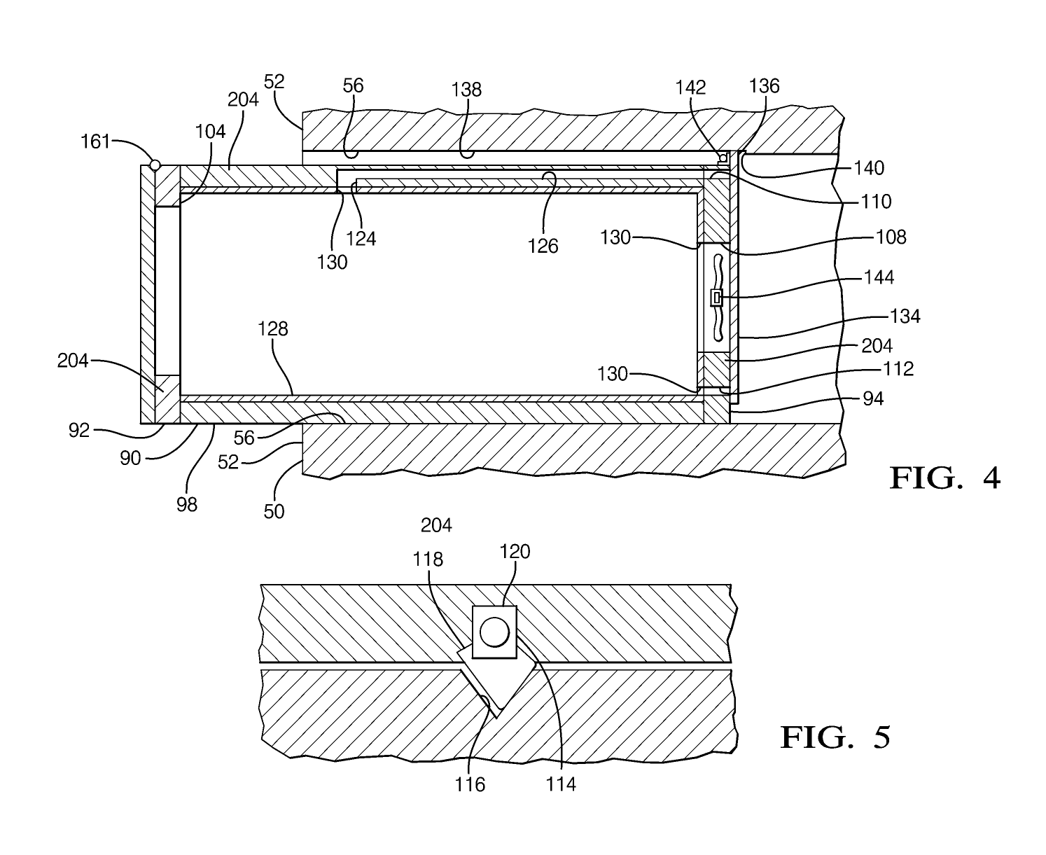

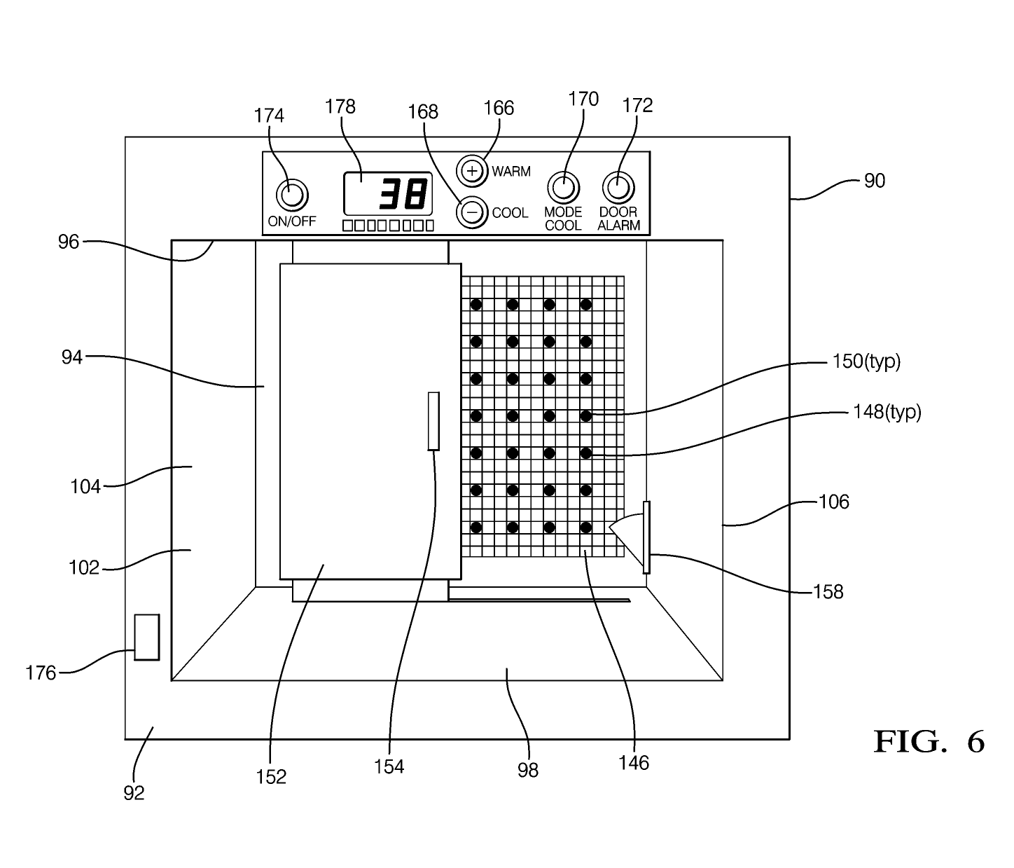

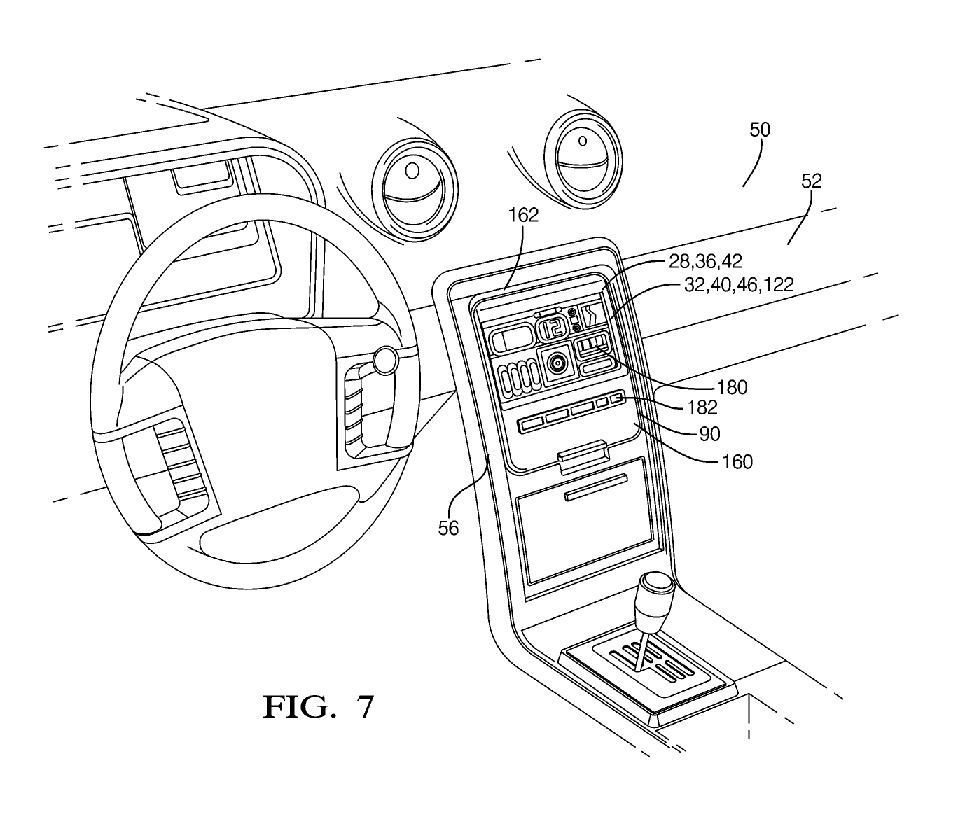

Referring to the Figures, wherein like numerals indicate corresponding parts throughout the several views, the invention comprises a vehicle having an instrument panel including an auxiliary article compartment as shown generally at FIG. 1. A vehicle body 20 has a firewall 22 disposed therein. The firewall 22 partitions the vehicle body 20 into a motor compartment 24 and a passenger compartment 26. A vehicle entertainment or audio-visual system 28 including an audio-visual control module 30 and audio-visual operator inputs 32 is disposed in the passenger compartment 26. A plurality of vehicle speakers 34 in electrical communication with the audio-visual control module 30 are disposed in the passenger compartment 26. A navigation system 36 including a navigation control module 38 and navigation operator inputs 40 is disposed in the passenger compartment 26. A heating ventilation and air conditioning (hereinafter HVAC) system HVAC system 42 including an HVAC control module 44 and HVAC operator inputs 46 is disposed in the passenger compartment 26. A vehicle signal transceiver 48 in electrical communication with the HVAC control module 44 and the audio-visual control module 30 and the navigation control module 38 is disposed in the passenger compartment 26.

A dash board or instrument panel 50 is disposed in the passenger compartment 26. The instrument panel 50 has a façade 52 and a backside 54 opposite the façade 52 and facing the firewall 22. The instrument panel 50 defines a passage 56 centrally in the instrument panel 50. The HVAC system 42 includes a housing 58 abutting the backside 54 of the instrument panel 50. The housing 58 defines an auxiliary aperture 60 for permitting flow of air from the housing 58 and at least one occupant aperture 62 for permitting flow of air from the housing 58 and a circulation aperture 64 for permitting flow of air into the housing 58 and an inlet opening 66 for permitting flow of air into the housing 58.

The HVAC system 42 includes an evaporator 68 for dehumidifying and chilling air disposed in the housing 58. The HVAC system 42 includes a blower 70 in electrical communication with the HVAC control module 44 and disposed in the housing 58 between the inlet opening 66 and the evaporator 68. The blower 70 draws air through the inlet opening 66 and the circulation aperture 64 into the housing 58 and blows air through the auxiliary aperture 60 and the occupant aperture 62 out of the housing 58. The inlet opening 66 and the blower 70 define a pre-treatment space 72 therebetween. The HVAC system 42 includes a heater 74 for heating air disposed in the housing 58 opposite of the evaporator 68 from the inlet opening 66. The evaporator 68 and the heater 74 define a first treatment space 76 therebetween. The heater 74 and the housing 58 define a second treatment space 78 therebetween.

The HVAC system 42 includes an occupant valve system 80 in electrical communication with the HVAC control module 44. The occupant valve system 80 includes at least one occupant flap 82 disposed adjacent the occupant aperture 62 and is movable for alternately permitting or preventing flow of air through the occupant aperture 62. The HVAC system 42 includes an auxiliary mix system 84 in electrical communication with the HVAC control module 44. The auxiliary mix system 84 is disposed in the housing 58 and has a pair of auxiliary flaps 86. The auxiliary flaps 86 are adjustable between a max first treatment arrangement and a max second treatment arrangement. The max first treatment arrangement is defined by the auxiliary flaps 86 isolating the auxiliary aperture 60 from the second treatment space 78 and exposing the auxiliary aperture 60 to the first treatment space 76. The max second treatment arrangement is defined by the auxiliary flaps 86 completely isolating the auxiliary aperture 60 from the first treatment space 76 and exposing the auxiliary aperture 60 to the second treatment space 78.

A vehicle battery 88 is disposed in the motor compartment 24 and is in electrical communication with and supplies electric power to the control modules 30, 38, 44, the vehicle speakers 34, the blower 70, the occupant valve system 80, the auxiliary mix system 84, and the vehicle signal transceiver 48.

An auxiliary article module 90 has walls 92, 94, 96, 98, 100, 102 defining an auxiliary article compartment 104. The walls 92, 94, 96, 98, 100, 102 include an obverse wall 92 defining an access opening 106 permitting transfer of articles into and out of the auxiliary article compartment 104. The walls 92, 94, 96, 98, 100, 102 include a reverse wall 94 opposite the obverse wall 92. The reverse wall 94 defines an auxiliary hole 108 for permitting flow of air into the auxiliary article compartment 104 and an outer circulation hole 110 for permitting flow of air from the auxiliary article compartment 104 and a drip hole 112 for permitting flow of liquid from the auxiliary article compartment 104.

An ejection-retention mechanism 114 retains the auxiliary article module 90 in a secured position and moves the auxiliary article module 90 from the secured position to an unsecured position. The ejection-retention mechanism 114 includes the instrument panel 50 defining a socket 116 in the passage 56 and the auxiliary article module 90 having a cam 118 being movable. The cam 118 alternately engages the socket 116 for securing the auxiliary article module 90 to the passage 56 in the secured position and pushes against the socket 116 for moving the auxiliary article module 90 from the secured position to the unsecured position and the cam 118 is disconnected from the socket 116 in the unsecured position. The ejection-retention mechanism 114 includes a cam motor 120 connected with the cam 118. The cam motor 120 alternately detains the cam 118 for holding the cam 118 in the socket 116 for holding the cam 118 in the socket 116 and securing the auxiliary article module 90 in the passage 56 in the secured position and turns the cam 118 to push the cam 118 against the socket 116 for moving the auxiliary article module 90 away from the housing 58 and from the secured position into the unsecured position.

The ejection-retention mechanism 114 includes an ejection-retention control input 122 in electrical communication with said cam motor 120 for activating the movement of the auxiliary article module 90 from the secured position to the unsecured position. The ejection-retention control input 122 is disposed on said auxiliary article module 90 and movable between a base position and a depressed position and having a position biasing component resisting movement of the ejection-retention control input 122 from the base position to the depressed position and returning the ejection-retention control input 122 from the depressed position to the base position.

The walls 92, 94, 96, 98, 100, 102 of the auxiliary article module 90 include side walls 96, 98, 100, 102 extending perpendicular to and between the reverse wall 94 and the obverse wall 92. The side walls 96, 98, 100, 102 including a top side wall 96 and a bottom side wall 98 parallel and opposite the top side wall 96 and facing downward. The side walls 96, 98, 100, 102 include a right side wall 100 extending perpendicular to and between the top side wall 96 and bottom side wall 98 and a left side wall 102 parallel and opposite the right side wall 100 and extending between the top side wall 96 and bottom side wall 98. The outer circulation hole 110 extends to the top side wall 96. The drip hole 112 is adjacent the bottom side wall 98 and opposite of the auxiliary hole 108 from the outer circulation hole 110.

The top side wall 96 defines an inner circulation hole 124. An inner duct 126 extends through the top side wall 96 from the auxiliary article compartment 104 to the outer circulation hole 110 for carrying air from the auxiliary article compartment 104 to the outer circulation hole 110. A liner 128 complementary to and engaging the reverse wall 94 and the side walls 96, 98, 100, 102 is removably disposed in the auxiliary article compartment 104 and defines liner openings 130 complementary to the inner circulation hole 124 and the auxiliary hole 108 and the drip hole 112.

An electrical power supply port 132 is disposed on the reverse wall 94 and faces away from the auxiliary article compartment 104. The vehicle battery 88 is in electrical communication with and supplies electric power to the electrical power supply port 132 in the secured position of the auxiliary article module 90 and is electronically isolated from the electrical power supply port 132 in the unsecured position.

A bias door 134 is supported by and connected to the reverse wall 94 adjacent the top side wall 96. The bias door 134 defines a tab 136 extending therefrom adjacent the top side wall 96. The bias door 134 is movable between a sealing position and an admitting position. The sealing position is defined by the bias door 134 being disposed over and covering the outer circulation hole 110 and the auxiliary hole 108 and the drip hole 112 for preventing flow from the auxiliary article compartment 104 of air and liquid through the outer circulation hole 110 and the auxiliary hole 108 and the drip hole 112. The admitting position is defined by the bias door 134 uncovering and exposing the outer circulation hole 110 and the auxiliary hole 108 and the drip hole 112 for permitting flow into and from the auxiliary article compartment 104 of air and liquid through the outer circulation hole 110 and the auxiliary hole 108 and the drip hole 112.

The instrument panel 50 defines a tab channel 138 complementary to the tab 136 in the passage 56. The tab channel 138 extends from the façade 52 to a tab stop 140 defined by the instrument panel 50 in the passage 56. The tab stop 140 contacts the tab 136 in the secured position of the auxiliary article module 90 and moves the bias door 134 from the sealing position to the admitting position. The tab 136 is disposed in the tab channel 138 for permitting the bias door 134 to move from the admitting position to the sealing position in the unsecured position of the auxiliary article module 90. A spring 142 has a first end fixed to the top side wall 96 and a second end fixed to the bias door 134. The spring 142 resists movement of the bias door 134 from the sealing position to the admitting position and biasing the bias door 134 from the admitting position to the sealing position.

A fan 144 for drawing air from the housing 58 through the auxiliary aperture 60 and the auxiliary hole 108 and blowing air into the auxiliary article compartment 104 is disposed in the auxiliary hole 108 and is supported by the reverse wall 94. A grille 146 for preventing articles in said auxiliary article compartment 104 from entering said auxiliary hole 108 is supported by the reverse wall 94 of the auxiliary article module 90 and is disposed over the auxiliary hole 108 between the auxiliary article compartment 104 and the fan 144. A plurality of red LED lights 148 and a plurality of blue LED lights 150 for illuminating said auxiliary article compartment 104 being supported by the reverse wall 94.

A roll-up door 152 is disposed opposite of the grille 146 from the fan 144. The roll-up door 152 is supported by the reverse wall 94 and the bottom side wall 98 and slidable across the auxiliary hole 108 from an open position to a partially closed position and to a fully closed position. The open position is defined by the roll-up door 152 completely uncovering the auxiliary hole 108. The partially closed position is defined by the roll-up door 152 partially blocking the auxiliary hole 108. The fully closed position is defined by the roll-up door 152 completely blocking the auxiliary hole 108. The roll-up door 152 has a roll-up handle 154 for gripping the roll-up door 152 being disposed thereon. An auxiliary control input 156 includes a switch 158 disposed in the auxiliary article compartment 104 on the reverse wall 94. The roll-up door 152 contacts the switch 158 and opens the switch 158 in the closed position of the roll-up door 152 and the switch 158 is closed in the partially closed and the fully open positions of the roll-up door 152.

An access door 160 is supported by the obverse wall 92 adjacent the access opening 106. The access door 160 is movable between a sealing position and an access position. The sealing position is defined by the access door 160 covering the access opening 106 for preventing transfer of items into and out of the auxiliary article compartment 104 and preventing flow through the access opening 106 of liquid and air. The access position is defined by the access door 160 uncovering the access opening 106 for permitting transfer of items into and out of the auxiliary article compartment 104.

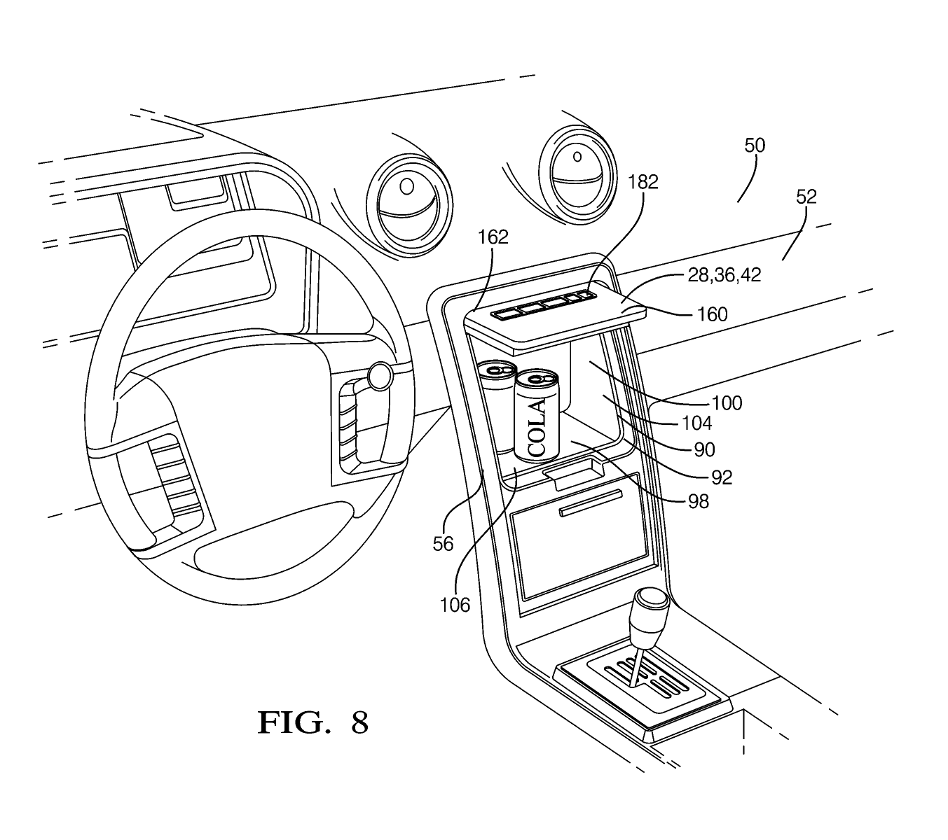

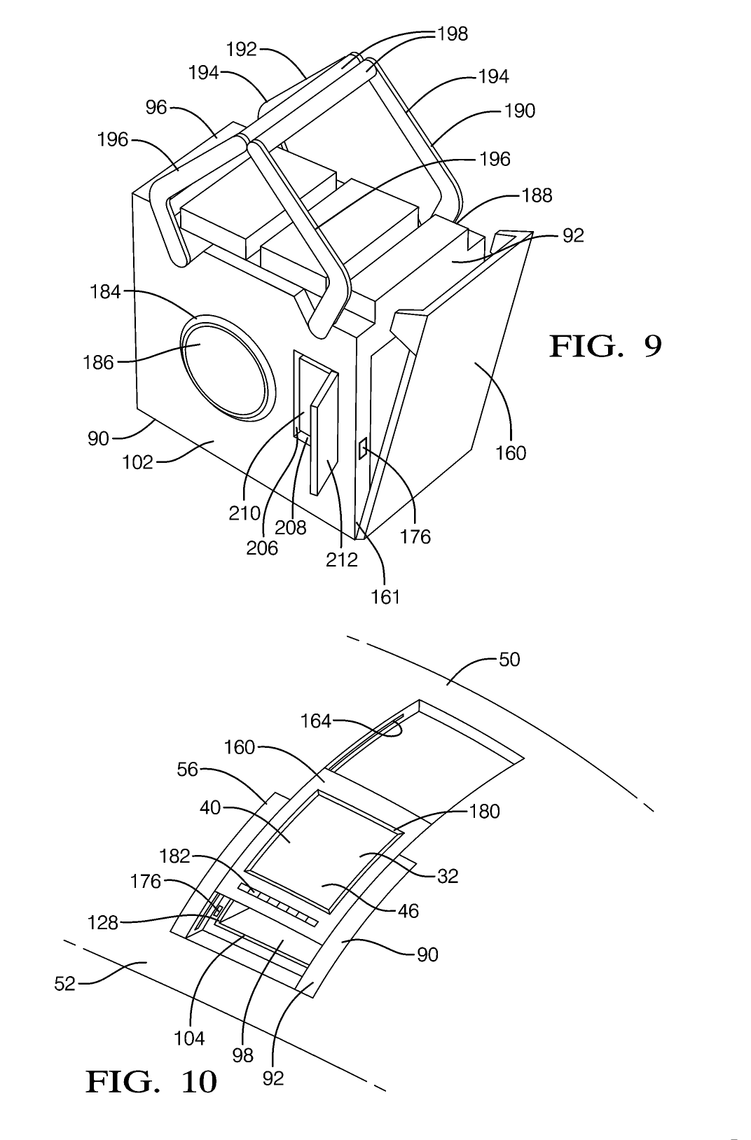

According to the embodiment shown in FIGS. 4, 8 and 9, an access hinge 161 rotatably connects the access door 160 and the obverse wall 92. The access door 160 and the façade 52 define one continuous surface in the secured position of the auxiliary article module 90 and in the sealing position of the access door 160. As shown in FIG. 9, the access hinge 161 is adjacent the bottom side wall 98 and the access position of the access door 160 is defined by the access door 160 being perpendicular with the obverse wall 92 and parallel and coplanar with the bottom side wall 98. As shown in FIG. 4, the access hinge 161 is adjacent the top side wall 96 and the access position of the access door 160 is defined by the access door 160 being perpendicular with the obverse wall 92 and parallel and coplanar with the top side wall 96. In the embodiment shown in FIG. 8, the top side wall 96 and the passage 56 define a slot 162 therebetween and the access door 160 is slidable in the slot 162. The access position is defined by the door being perpendicular to the façade 52 and disposed in the slot 162.

According to the embodiment shown in FIG. 10, the obverse wall 92 and the façade 52 define a pair of tracks 164. The tracks 164 support the access door 160 and the access door 160 is slideable on the tracks 164 along the façade 52 between the access position and the sealing position.

The auxiliary control input 156 includes an on/off button and a temperature setting increase button 166 and a temperature setting decrease button 168 and a max cool button 170 and a door chime button 172 disposed on the obverse wall 92. Each of the buttons 166, 168, 170, 172, 174 are depressable and covered by the access door 160 in the sealing position and are uncovered by the access door 160 in the access position. An access shut sensor 176 is disposed on the obverse wall 92 and detects the shut position of the access door 160. An auxiliary display screen 178 is disposed on the obverse wall 92 and is covered by the access door 160 in the sealing position of the access door 160 and is uncovered by the access door 160 in the access position of the access door 160.

A main display screen 180 is touch sensitive and is disposed on the access door 160. The operator inputs 32, 40, 46 are disposed on and are in electrical communication with the main display screen 180. Electrical accessory ports 182 for receiving portable media players and phones are disposed on the access door 160. The ejection-retention control input 122 is disposed on the access door 160.

The right side wall 100 and the left side wall 102 each define a speaker opening 184. An auxiliary speaker 186 is disposed in each of the speaker openings 184. The top side wall 96 and left side wall 102 and right side wall 100 define a handle depression 188. A front carrying handle 190 and a rear carrying handle 192 each has a right arm 194 rotatably attached to the right side wall 100 in the handle depression 188 and a left arm 196 hingedly attached to the left side wall 102 in the handle depression 188. A grip 198 extends between the right arm 194 and the left arm 196. The arms 194, 196 of the front carrying handle 190 are attached to the left and right side walls 102, 100 adjacent the obverse wall 92 and the arms 194, 196 of the rear carrying handle 192 being attached to the left and right side walls 102, 100 adjacent the reverse side wall. Each of the carrying handles are rotatable between a stowed position and a carrying position. The stowed position is defined by the carrying handles being disposed entirely within the handle depression 188. The carrying position is defined by the carrying handles being rotated out from the handle depression 188 and the grips 198 being adjacent each other.

The bottom side wall 98 defines a plurality of drink holders 200 in the auxiliary article compartment 104 and each is circular in shape. Each the walls 92, 94, 96, 98, 100, 102 define an interstitial space 202 internal to each wall. Insulation filler 204 is fixedly disposed in and fills each interstitial space 202. Each of the side walls 96, 98, 100, 102 defines a pocket opening 206 and a pocket 208 extending from the pocket opening 206 into the interstitial space 202. Insulation inserts 210 that are insulative are removably inserted in each of the pockets 208. Each of the sides walls 92, 94, 96, 98, 100, 102 of the auxiliary article module 90 include a pocket door 212. Each of the pocket doors 212 are reversibly closable over the pocket opening 206 and retain the insulation inserts 210 in the pockets 208.

An auxiliary signal transceiver 214 is disposed in the interstitial space 202 of the top side wall 96. The auxiliary signal transceiver 214 is in electrical communication with the red LED lights 148, the blue LED lights 150, the fan 144, the auxiliary display screen 178, the main display screen 180, the access shut sensor 176, the auxiliary speakers 186, the cam motor 120, the electrical accessory ports 182, the auxiliary control input 156, and the operator inputs 32, 40, 46. The auxiliary signal transceiver 214 is in wireless communication with the vehicle signal transceiver 48.

An auxiliary battery 216 is rechargeable and is disposed in the interstitial space 202 of the bottom side wall 98. The auxiliary battery 216 is in electrical communication with and supplies electric power to the fan 144, the main display screen 180, the auxiliary display screen 178, the auxiliary speakers 186, the red LED lights 148, the blue LED lights 150, the electrical accessory ports 182, the auxiliary signal transceiver 214, and the cam motor 120. The auxiliary battery 216 is in electrical communication with the electrical power supply port 132.

Depressing of the on/off button zero or an odd number of times as the switch 158 is closed causes the fan 144 to draw air from the housing 58 through the auxiliary aperture 60 and the auxiliary hole 108 and blows air into the auxiliary article compartment 104. Depressing of the on/off button an odd number of times as the switch 158 is closed causes the fan 144 to abstain from drawing and blowing air.

The HVAC control module 44 has an auxiliary temperature setting that is the desired temperature inside the auxiliary article compartment 104. The main display screen 180 displays the auxiliary temperature setting. The auxiliary display screen 178 displays the auxiliary temperature setting as the access door 160 is in the access position. Depressing of the temperature setting increase button 166 raises the auxiliary temperature setting and the auxiliary mix system 84 moves the auxiliary flaps 86 toward the max second treatment position. Depressing of the temperature setting decrease button 168 lowers the auxiliary temperature setting and the auxiliary mix system 84 moves the auxiliary flaps 86 toward the max first treatment position. Depressing of the max cool button 170 lowers the auxiliary temperature setting the auxiliary mix systems 84 move the auxiliary flaps 86 to the max first treatment position.

The access shut sensor 176 communicates with the HVAC control module 44 the access door 160 being in the access position. Depressing of the door alarm button zero or an even number of times causes the HVAC control module 44 to chime the vehicle speakers 34 as the access shut sensor 176 senses the access door 160 being in the access position. Depressing of the door alarm button an odd number of times causes the HVAC control module 44 to abstain from chiming the vehicle speakers 34 as the access shut sensor 176 senses the access door 160 being in the access position.

The HVAC control module 44 has a predetermined temperature setting threshold of seventy degrees Fahrenheit. The blue LED lights 150 illuminate the auxiliary article compartment 104 in response to said auxiliary temperature setting being below the predetermined temperature setting threshold and the access door 160 being in the access position. The red LED lights 148 illuminate the auxiliary article compartment 104 in response to said auxiliary temperature setting being at or above the predetermined temperature setting threshold and the access door 160 being in the access position.

The passage 56 extends from the façade 52 to the backside 54 and terminates at the housing 58. The auxiliary article module 90 is disposed in the passage 56 and the reverse wall 94 abuts the housing 58 and the auxiliary hole 108 is aligned with and abutting the auxiliary aperture 60 for receiving air from the housing 58 in the auxiliary article compartment 104 in the secured position. The circulation aperture 64 is aligned with and abuts the outer circulation hole 110 for receiving air from the auxiliary article module 90 in the secured position into the housing 58. A circulation duct 218 extends between the circulation aperture 64 and the pre-treatment space 72 for carrying air from the auxiliary article compartment 104 to the pre-treatment space 72 of the housing 58. The housing 58 defines a drip aperture for permitting flow of liquid into the housing 58 and the drip aperture is aligned with and abutting the drip opening in the secured position of the auxiliary article module 90 for receiving liquid from the auxiliary article compartment 104 into the housing 58.

Accordingly, the blower 70 draws air from the pre-treatment space 72 and blows air across the evaporator 68 and the heater 74 through the auxiliary aperture 60 and the auxiliary hole 108 and into the auxiliary article compartment 104. The fan 144 blows the air from the auxiliary article compartment 104 through the inner circulation hole 124 and the inner duct 126 and the outer circulation hole 110 and the circulation aperture 64 and the circulation duct 218 and to the pre-treatment space 72.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A vehicle having an instrument panel including an auxiliary article compartment comprising:
an instrument panel having a façade and a backside opposite said façade and defining a passage,
an HVAC system including a housing abutting said backside of said instrument panel and defining an auxiliary aperture for permitting flow of air and an occupant aperture for permitting flow of air and having at least a first treatment device disposed therein for treating air,
an auxiliary article module having walls defining an auxiliary article compartment and an auxiliary hole for permitting flow of air into said auxiliary article compartment, and
said passage extending from said façade to said backside and terminating at said housing and said auxiliary article module being disposed in said passage and abutting said housing and said auxiliary hole being aligned with and abutting said auxiliary aperture for receiving air from said housing into said auxiliary article compartment.

2. A vehicle as set forth in claim 1 including an ejection-retention mechanism for alternately retaining said auxiliary article module in a secured position defined by said auxiliary article module being disposed in said passage and abutting said housing and said auxiliary aperture being aligned with and abutting said auxiliary hole and moving said auxiliary article module from said secured position to an unsecured position defined by said auxiliary article module being spaced from said housing.

3. A vehicle as set forth in claim 2 wherein said auxiliary article module defines an outer circulation hole for permitting flow air from said auxiliary article compartment and said housing defines a circulation aperture for permitting flow of air aligned with and abutting said outer circulation hole in said secured position for receiving air from said auxiliary article module in said secured position into said housing.

4. A vehicle as set forth in claim 3 including said housing defining an inlet opening for permitting flow of air and said inlet opening and said first treatment device defining a pre-treatment space therebetween and a circulation duct extending between said circulation aperture and said pre-treatment space for carrying air from said auxiliary article compartment to said pre-treatment space of said housing.

5. A vehicle as set forth in claim 3 wherein said auxiliary article module defines a drip hole for permitting flow of liquid from said auxiliary article compartment and said housing defines a drip aperture for permitting flow of liquid into said housing and being aligned with and abutting said drip hole in said secured position of said auxiliary article module for receiving liquid from said auxiliary article compartment into said housing.

6. A vehicle as set forth in claim 2 wherein said ejection-retention mechanism includes said instrument panel defining a socket in said passage and said auxiliary article module having a cam being movable and said cam alternately engaging said socket for securing said auxiliary article module to said passage in said secured position and said cam pushing against said socket for moving said auxiliary article module from said secured position to said unsecured position and said cam being disconnected from said socket in said unsecured position and a cam motor connected with said cam and said cam motor alternately detaining said cam for holding said cam in said socket and securing said auxiliary article module to said passage in said secured position and turning said cam to push said cam against said socket for moving said auxiliary article module away from said housing and from said secured position into said unsecured position and an ejection-retention control input in electrical communication with said cam motor for activating the movement of said auxiliary article module from said secured position to said unsecured position being disposed on said auxiliary article module and movable between a base position and a depressed position and having a position biasing component resisting movement of said ejection-retention control input from said base position to said depressed position and returning said ejection-retention control input from said depressed position to said base position.

7. A vehicle as set forth in claim 5 wherein said walls include an obverse wall defining an access opening for permitting transfer of articles into and out of said auxiliary article compartment and a reverse wall opposite said obverse wall and defining said auxiliary hole and said outer circulation hole and said drip hole and said walls include side walls extending perpendicular to and between said reverse wall and said obverse wall and said side walls include a top side wall and a bottom side wall parallel and opposite said top side wall and facing downward and a right side wall extending perpendicular to and between said top and bottom side walls and a left side wall parallel and opposite said right side wall and extending between said top and bottom side walls and said outer circulation hole extending to said top side wall and said drip hole being adjacent said bottom side wall and opposite of said auxiliary hole from said outer circulation hole and said top side wall defining an inner circulation hole and having an inner duct extending therethrough from said auxiliary article compartment to said outer circulation hole for carrying air from said auxiliary article compartment to said outer circulation hole and a liner complementary to and engaging said reverse wall and said side walls removably disposed in said auxiliary article compartment and defining liner openings complementary to said inner circulation hole and said auxiliary hole and said drip hole.

8. A vehicle as set forth in claim 7 including a bias door supported by and connected to said reverse wall adjacent said top side wall and defining a tab extending therefrom adjacent said top side wall and said bias door being movable between a sealing position defined by said bias door being disposed over and covering said outer circulation hole and said auxiliary hole and said drip hole for preventing flow of air and liquid through said outer circulation hole and said auxiliary hole and said drip hole and an admitting position defined by said bias door uncovering and exposing said outer circulation hole and said auxiliary hole and said drip hole for permitting flow of air and liquid through said outer circulation hole and said auxiliary hole and said drip hole and said instrument panel defining a tab channel complementary to said tab in said passage and extending from said façade to a tab stop defined by said instrument panel in said passage for contacting said tab stop in said secured position of said auxiliary article module and moving said bias door from said sealing position to said admitting position and said tab being disposed in said tab channel for permitting movement of said bias door from said admitting position to said sealing position in said unsecured position of said auxiliary article module and a spring having a first end fixed to said top side wall and a second end fixed to said bias door for resisting movement of said bias door from said sealing position to said admitting position and biasing said bias door from said admitting position to said sealing position.

9. A vehicle as set forth in claim 4 including said HVAC system including a second treatment device disposed in said housing opposite of said first treatment device from said inlet opening for treating air and said first treatment device and said second treatment device defining a first treatment space therebetween and said second treatment device and said housing defining a second treatment space therebetween and an auxiliary mix system disposed in said housing having at least one auxiliary flap adjustable between a max first treatment arrangement defined by said auxiliary flap isolating said auxiliary aperture from said second treatment space and exposing said auxiliary article module inlet aperture to said first treatment space and a max second treatment arrangement defined by said auxiliary flap completely isolating said auxiliary aperture from said first treatment space and exposing said auxiliary aperture to said second treatment space and an occupant valve system including at least one occupant flap disposed adjacent said occupant aperture and movable for alternately permitting or preventing flow of air through said occupant aperture.

10. A vehicle as set forth in claim 9 including said first treatment device being an evaporator for dehumidifying and chilling air and said second treatment device being a heater for heating air and a blower disposed between said inlet opening and said evaporator for drawing air through said inlet opening and said circulation aperture into said housing and blowing air through said auxiliary aperture and said occupant aperture out of said housing and said inlet opening and said blower defining said pre-treatment space therebetween.

11. A vehicle as set forth in claim 7 including an electrical power supply port disposed on said reverse wall facing away from said auxiliary article compartment and a vehicle battery in electrical communication with and supplying electric power to said electrical power supply port in said secured position of said auxiliary article module and being electronically isolated from said electrical power supply port in said unsecured position of said auxiliary article module and an auxiliary battery being rechargeable and disposed in said auxiliary article module and in electrical communication with said electrical power supply port.

12. A vehicle as set forth in claim 11 including an access door supported by said obverse wall adjacent said access opening and movable between a sealing position defined by said access door covering said access opening for preventing transfer of items into and out of said auxiliary article compartment and preventing flow through said access opening of liquid and air and an access position defined by said access door uncovering said access opening for permitting transfer of items into and out of said auxiliary article compartment and an access shut sensor disposed on said obverse wall and detecting said sealing position of said access door and an auxiliary display screen disposed on said obverse wall and being covered by said access door in said sealing position of said access door and being uncovered by said access door in said access position of said access door and electrical accessory ports disposed on said access door.

13. A vehicle as set forth in claim 12 including an audio-visual system including an audio-visual control module and audio-visual operator inputs and vehicle speakers in electrical communication with said audio-visual control module and a navigation system including a navigation control module and navigation operator inputs and said HVAC system including an HVAC control module and HVAC operator inputs and said vehicle battery in electrical communication with and supplying electric power to said control modules and said vehicle speakers and a main display screen being touch sensitive and disposed on said access door and said operator inputs disposed on and in electrical communication with said main display screen with said passage disposed centrally in said instrument panel.

14. A vehicle as set forth in claim 13 including a fan for drawing air from said housing through said auxiliary aperture and said auxiliary hole and blowing air into said auxiliary article compartment disposed in said auxiliary hole and supported by said reverse wall and a grille for preventing articles in said auxiliary article compartment from entering said auxiliary hole being supported by said reverse wall and disposed over said auxiliary hole between auxiliary article compartment and said fan and a plurality of red LED lights and a plurality of blue LED lights for illuminating said auxiliary article compartment in said access position of said access door being supported by said reverse wall and an auxiliary signal transceiver in electrical communication with said red and blue LED lights and said fan and operator inputs and said main display screen and said auxiliary display screen and said access shut sensor and said electrical accessory ports and said auxiliary battery in electrical communication with and supplying electric power to said auxiliary signal transceiver and said fan and said red and blue LED lights and said auxiliary display screen and said main display screen and said electrical accessory ports and a vehicle signal transceiver in electrical communication with said control modules and in wireless communication with said auxiliary signal transceiver and said vehicle battery in electrical communication with and supplying electric power to said vehicle signal transceiver.

15. A vehicle as set forth in claim 14 including a roll-up door disposed opposite said grille from said fan and supported by said reverse wall and said bottom side wall and slidable across said auxiliary hole from an open position defined by said roll-up door completely uncovering said auxiliary hole to a partially closed position defined by said roll-up door partially blocking said auxiliary hole and to a fully closed position defined by said roll-up door completely blocking said auxiliary hole and having a roll-up handle for gripping the roll-up door being disposed thereon and an auxiliary control input in electrical communication with said auxiliary signal transceiver including a switch disposed in said auxiliary article compartment on said reverse wall and said roll-up door contacting said switch and opening said switch in said closed position of said roll-up door and said switch being closed in said partially closed and said fully open positions of said roll-up door and said auxiliary article module control input includes an on/off button and a temperature setting increase button and a temperature setting decrease button and a max cool button and a door chime button each disposed on said obverse wall and each said button being depressable and covered by said access door in said sealing position and being exposed by said access door in said access position.

16. A vehicle as set forth in claim 7 wherein each of said walls define a interstitial space internal to each said wall and insulation filler fixedly disposed in and filling each said interstitial space and each of said side walls defining a pocket opening and a pocket extending from said pocket opening into said interstitial space and insulation inserts being insulative and removably inserted in each said pocket and each of said side walls of said auxiliary article module including a pocket door reversibly closable over said pocket opening and retaining said insulation inserts in said pockets and said top and left and right side walls defining a handle depression and a front carrying handle and a rear carrying handle each having a right arm rotatably attached to said right side wall in said handle depression and a left arm hingedly attached to said left side wall in said handle depression and a grip extending between said right arm and said left arm with said arms of said front carrying handle being attached to said left and right side walls adjacent said obverse wall and said arms of said rear carrying handle being attached to said left and right side walls adjacent said reverse side wall and each of said carrying handles being rotatable between a stowed position defined by said carrying handles being disposed entirely within said handle depression and a carrying position defined by said carrying handles being rotated out from said handle depression and said grips being adjacent each other and said right side wall and said left side wall each defining a speaker opening and an auxiliary speaker disposed in each said speaker opening and said bottom side wall defining a plurality of drink holders in said auxiliary article compartment and being circular in shape.

17. A vehicle as set forth in claim 1 including a vehicle body and a firewall disposed in said vehicle and partitioning said vehicle into a motor compartment and a passenger compartment and said instrument panel and said housing being disposed in said passenger compartment.

18. A vehicle as set forth in claim 15 including said housing defining an inlet opening for permitting flow of air and including said first treatment device being an evaporator for dehumidifying and chilling air and said HVAC system including a blower in electrical communication with said HVAC control module and said vehicle battery in electrical communication with and supplying electric power to said blower and said blower disposed between said inlet opening and said evaporator for drawing air through said inlet opening and said circulation aperture into said housing and blowing air through said auxiliary aperture and said occupant aperture out of said housing and said inlet opening and said blower defining a pre-treatment space therebetween and a circulation duct extending between said circulation aperture and said pre-treatment space for carrying air from said auxiliary article compartment to said pre-treatment space of said housing and said housing having a heater disposed opposite of said evaporator from said inlet opening for heating air and said evaporator and said heater defining a first treatment space therebetween and said heater and said housing defining a second treatment space therebetween,
said HVAC system including an occupant valve system in electrical communication with said HVAC module and said vehicle battery in electrical communication with and supplying electric power to said occupant valve system and said occupant valve system including at least one occupant flap disposed adjacent said occupant aperture and movable for alternately permitting or preventing flow of air through said occupant aperture,
said HVAC system including an auxiliary mix system in electrical communication with said HVAC control module and said vehicle battery in electrical communication with and supplying electric power to said auxiliary mix system and said auxiliary mix system disposed in said housing and having at least one auxiliary flap adjustable between a max first treatment arrangement defined by said auxiliary flap isolating said auxiliary aperture from said second treatment space and exposing said auxiliary article module inlet aperture to said first treatment space and a max second treatment arrangement defined by said auxiliary flap completely isolating said auxiliary aperture from said first treatment space and exposing said auxiliary aperture to said second treatment space,
a vehicle body and a firewall disposed in said vehicle and partitioning said vehicle into a motor compartment and a passenger compartment and said instrument panel and said housing being disposed in said passenger compartment,
said ejection-retention mechanism including said instrument panel defining a socket in said passage and said auxiliary article module having a cam being movable and said cam alternately engaging said socket for securing said auxiliary article module to said passage in said secured position and said cam pushing against said socket for moving said auxiliary article module from said secured position to said unsecured position and said cam being disconnected from said socket in said unsecured position,
said ejection-retention mechanism including a cam motor and said auxiliary battery in electrical communication with and supplying electric power to said cam motor and said cam motor being connected with said cam and said cam motor alternately detaining said cam for holding said cam in said socket and securing said auxiliary article module in said passage in said secured position and turning said cam to push said cam against said socket for moving said auxiliary article module away from said housing and from said secured position into said unsecured position,
said ejection-retention mechanism including an ejection-retention control input disposed on said access door and in electrical communication with said cam motor for activating the movement of said auxiliary article module from said secured position to said unsecured position being disposed on said obverse wall and movable between a base position and a depressed position and having a position biasing component resisting movement of said ejection-retention control input from said base position to said depressed position and returning said ejection-retention control input from said depressed position to said base position,
a bias door supported by and connected to said reverse wall adjacent said top side wall and defining a tab extending therefrom adjacent said top side wall and said bias door being movable between a sealing position defined by said bias door being disposed over and covering said outer circulation hole and said auxiliary hole and said drip hole for preventing flow of air and liquid through said outer circulation hole and said auxiliary hole and said drip hole and an admitting position defined by said bias door uncovering and exposing said outer circulation hole and said auxiliary hole and said drip hole for permitting flow of air and liquid through said outer circulation hole and said auxiliary hole and said drip hole,
said instrument panel defining a tab channel complementary to said tab in said passage and extending from said façade to a tab stop defined by said instrument panel in said passage for contacting said tab stop in said secured position of said auxiliary article module and moving said bias door from said sealing position to said admitting position and said tab being disposed in said tab channel for permitting movement of said bias door from said admitting position to said sealing position in said unsecured position of said auxiliary article module,
a spring having a first end fixed to said top side wall and a second end fixed to said bias door for resisting movement of said bias door from said sealing position to said admitting position and biasing said bias door from said admitting position to said sealing position,
including each of said walls defining a interstitial space internal to each said wall,
insulation filler fixedly disposed in and filling each said interstitial space,
each of said side walls defining a pocket opening and a pocket extending from said pocket opening into said interstitial space,
insulation inserts being insulative and removably inserted in each said pocket,
each of said side walls of said auxiliary article module including a pocket door reversibly closable over said pocket opening and retaining said insulation inserts in said pockets,
said top and left and right side walls defining a handle depression,
a front carrying handle and a rear carrying handle each having a right arm rotatably attached to said right side wall in said handle depression and a left arm hingedly attached to said left side wall in said handle depression and a grip extending between said right arm and said left arm with said arms of said front carrying handle being attached to said left and right side walls adjacent said obverse wall and said arms of said rear carrying handle being attached to said left and right side walls adjacent said reverse side wall and each of said carrying handles being rotatable between a stowed position defined by each of said carrying handles being disposed entirely within said handle depression and a carrying position defined by said carrying handles being rotated out from said handle depression and said grips being adjacent each other,
said right side wall and said left side wall each defining a speaker opening and an auxiliary speaker disposed in each said speaker opening and in electrical communication with said auxiliary signal transceiver and said auxiliary battery in electrical communication with and supplying electric power to said auxiliary speakers, and
said bottom side wall defining a plurality of drink holders in said auxiliary article compartment and being circular in shape.

19. A vehicle as set forth in claim 18 wherein an access hinge rotatably connects said access door and said obverse wall and said access door and said façade define one continuous surface in said secured position of said auxiliary article module and in said sealing position of said access door.

20. A vehicle as set forth in claim 19 wherein said access hinge is adjacent said bottom side wall and said access position defined by said access door being perpendicular with said obverse wall and parallel and coplanar with said bottom side wall.

21. A vehicle as set forth in claim 19 wherein said access hinge is adjacent said top side wall and said passage define a slot therebetween and said access door being slidable in said slot and said access position defined by said door being perpendicular to said façade and disposed in said slot.

22. A vehicle as set forth in claim 18 wherein said obverse wall and said façade define a pair of tracks and said tracks support said access door and said access door slideable on said tracks along said façade between said access position and said sealing position.
